(19) United States
(12) Patent Application Publication
(10) Pub. No.: US 2018/0195332 A1
(43) Pub. Date: Jul. 12, 2018

(54) SYSTEM WITH PULLEYS AND STEEL CABLE FOR PICK UP TRUCK END GATE POSITION ADJUSTMENT

(71) Applicant: GM GLOBAL TECHNOLOGY OPERATIONS LLC, Detroit, MI (US)

(72) Inventors: Marcel W. Martins, Campinas (BR); Aaron R. Carmona, Santo Andre (BR); Claudinei L. Viegas, Sao Bernardo do Campo (BR)

(21) Appl. No.: 15/402,845

(22) Filed: Jan. 10, 2017

(51) Int. Cl. E05F 5/00; B62D 33/027; B62D 33/03; E05D 11/06

(52) U.S. Cl. CPC E05F 5/00; B62D 33/0273; B62D 33/03; E05Y 2900/546; E05Y 2201/21; E05Y 2201/214; E05D 11/06

(57) ABSTRACT

A cargo box for a pickup truck includes a base portion having a first end, a second end, and an intermediate portion defining the cargo box. A first side wall extends on a first side of the cargo box. A second side wall extends on a second side of the cargo box. An end gate is pivotally mounted at the second end of the base portion. The end gate includes a selectively releasable support member. The end gate is shiftable between a first position wherein the end gate is linked to the first and second side walls, a second position wherein the end gate is arranged at a first angle relative to the base portion, and upon release of the support member a third position wherein the end gate is arranged at a second angle, greater than the first angle, relative to the base portion.

### INTRODUCTION

Exemplary embodiments relate to the art of vehicles and, more particularly, to an integrated step assembly for a pickup truck box.

Vehicles, such as pickup trucks, may include a cargo box that is utilized to transport various goods, tools, materials, and the like. Access to a front portion of the box can be difficult. To provide access to a front box zone, many users or dealers install assist steps that may take the form of a wheel-to-wheel running board or fold down, frame mounted steps. Options such as running boards and fold down steps are not available on all models, and are typically low to the ground thereby providing only limited access to the cargo box.

Other solutions to providing access include integrating steps or step side trucks. More specifically, steps are integrated into outer body panels of the cargo box. Integrated steps are typically tied into or partially supported by braces extending from box cross sills. Step side trucks required a specific shape and material for the cargo box that is not desired by all consumers. Further, step side trucks provide only limited access to front portions of the cargo box. Accordingly, it is desirable to provide a step that does not impact body styles and yet is positioned to provide expanded access to front portions of a cargo box.

### SUMMARY

In accordance with an exemplary embodiment, a cargo box for a pickup truck includes a base portion having a first end, a second end, and an intermediate portion defining the cargo box. A first side wall extends from the first end towards the second end on a first side of the cargo box. The first side wall includes a first end portion. A second side wall extends from the first end towards the second end on a second side of the cargo box. The second side wall includes a second end portion. An end gate is pivotally mounted at the second end of the base portion. The end gate includes a selectively releasable support member. The end gate is shiftable between a first position wherein the end gate is linked to the first and second side walls, a second position wherein the end gate is arranged at a first angle relative to the base portion, and upon release of the support member a third position wherein the end gate is arranged at a second angle, greater than the first angle, relative to the base portion.

In addition to one or more of the features described above or below, or as an alternative, further embodiments could include at least one selectively releasable pulley mounted to the end gate, the selectively releasable support member extending from the at least one selectively releasable pulley to one of the first and second side walls.

In addition to one or more of the features described above or below, or as an alternative, further embodiments could include wherein the end gate includes a first side portion and an opposing second side portion, the at least one selectively releasable pulley being mounted to one of the first and second side portions.

In addition to one or more of the features described above or below, or as an alternative, further embodiments could include a release mechanism mounted to the end gate and selectively linked with the at least one selectively releasable pulley, the release mechanism being operable to release the selectively releasable pulley allowing the end gate to transition between the second position and the third position.

In addition to one or more of the features described above or below, or as an alternative, further embodiments could include an end gate handle mounted to the end gate, the end gate handle being operatively coupled to the release mechanism.

In addition to one or more of the features described above or below, or as an alternative, further embodiments could include wherein the end gate handle is mounted to the end gate substantially centrally between the first and second side portions.

In addition to one or more of the features described above or below, or as an alternative, further embodiments could include wherein the release mechanism includes a spring element and a release element, the spring element biasing the release element into the at least one selectively releasable pulley.

In addition to one or more of the features described above or below, or as an alternative, further embodiments could include wherein the end gate handle is mechanically linked to the spring element through an actuator element.

In addition to one or more of the features described above or below, or as an alternative, further embodiments could include wherein the selectively releasable support member comprises a flexible cable having a first end coupled to the at least one selectively releasable pulley and a second end coupled to the cargo box.

In addition to one or more of the features described above or below, or as an alternative, further embodiments could include an anchor member mounted to one of the first and second side walls, the second end of the flexible cable being connected to the anchor member.

In accordance with another aspect of an exemplary embodiment, a vehicle includes a body, and a cargo box mechanically connected to the body. The cargo box includes a base portion having a first end, a second end, and an intermediate portion defining the cargo box. A first side wall extends from the first end towards the second end on a first side of the cargo box. The first side wall includes a first end portion. A second side wall extends from the first end towards the second end on a second side of the cargo box. The second side wall includes a second end portion. An end gate is pivotally mounted at the second end of the base portion. The end gate includes a selectively releasable support member. The end gate is shiftable between a first position wherein the end gate is linked to the first and second side walls, a second position wherein the end gate is arranged at a first angle relative to the base portion, and upon release of the support member a third position wherein the end gate is arranged at a second angle, greater than the first angle, relative to the base portion.

In addition to one or more of the features described above or below, or as an alternative, further embodiments could include at least one selectively releasable pulley mounted to the end gate, the selectively releasable support member extending from the at least one selectively releasable pulley to one of the first and second side walls.

In addition to one or more of the features described above or below, or as an alternative, further embodiments could include wherein the end gate includes a first side portion and an opposing second side portion, the at least one selectively releasable pulley being mounted to one of the first and second side portions.

In addition to one or more of the features described above or below, or as an alternative, further embodiments could include a release mechanism mounted to the end gate and selectively linked with the at least one selectively releasable pulley, the release mechanism being operable to release the selectively releasable pulley allowing the end gate to transition between the second position and the third position.

In addition to one or more of the features described above or below, or as an alternative, further embodiments could include an end gate handle mounted to the end gate, the end gate handle being operatively coupled to the release mechanism.

In addition to one or more of the features described above or below, or as an alternative, further embodiments could include wherein the end gate handle is mounted to the end gate substantially centrally between the first and second side portions.

In addition to one or more of the features described above or below, or as an alternative, further embodiments could include wherein the release mechanism includes a spring element and a release element, the spring element biasing the release element into the at least one selectively releasable pulley.

In addition to one or more of the features described above or below, or as an alternative, further embodiments could include wherein the end gate handle is mechanically linked to the spring element through an actuator element.

In addition to one or more of the features described above or below, or as an alternative, further embodiments could include wherein the selectively releasable support member comprises a flexible cable having a first end coupled to the at least one selectively releasable pulley and a second end coupled to the cargo box.

In addition to one or more of the features described above or below, or as an alternative, further embodiments could include an anchor member mounted to one of the first and second side walls, the second end of the flexible cable being connected to the anchor member.

The above features and advantages and other features and advantages of the exemplary embodiments are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of a vehicle having an end gate depicted in an open configuration, in accordance with an exemplary embodiment;

FIG. 2 is a perspective view of the vehicle of FIG. 1 depicting the end gate in a closed configuration, in accordance with an exemplary embodiment;

FIG. 3 is a is a perspective view of the vehicle of FIG. 1 depicting the end gate in an intermediate position, in accordance with an exemplary embodiment

FIG. 4 is a detail view of the end gate in the intermediate position;

FIG. 5 is a detail view of the end gate in the open position of FIG. 1;

FIG. 6 depicts a selectively releasable pulley of the end gate, in accordance with an exemplary embodiment;

FIG. 7 depicts a release mechanism of the end gate, in accordance with an exemplary embodiment; and

FIG. 8 depicts a return spring of the selectively releasable pulley, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

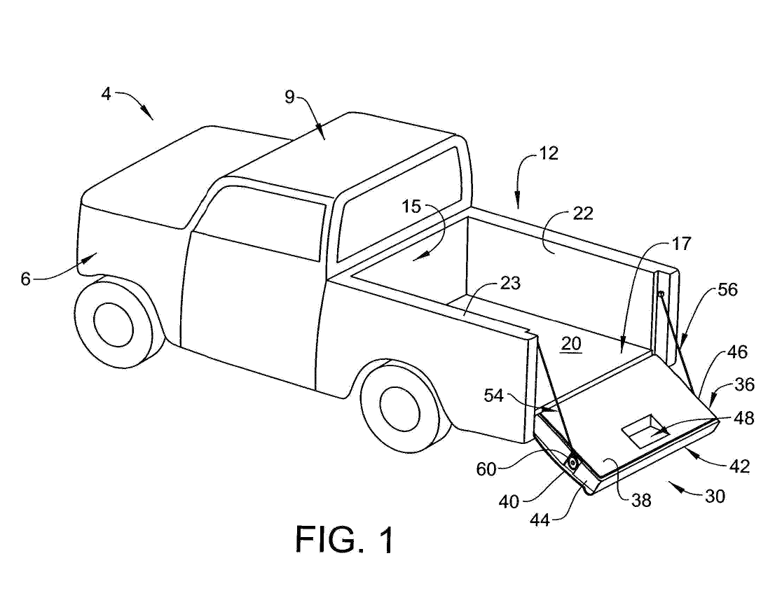

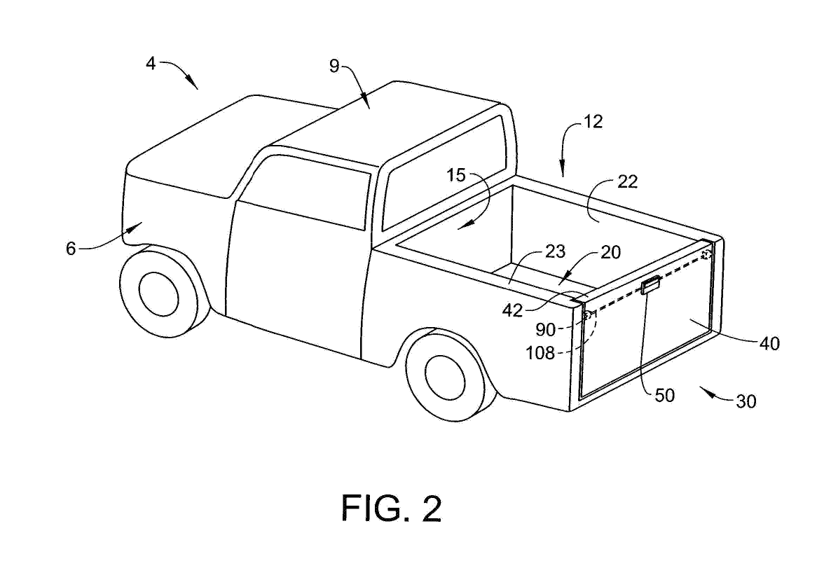

Referring to FIGS. 1 and 2, a motor vehicle, in accordance with an exemplary embodiment, is indicated generally at 4. Motor vehicle 4 includes a body 6 including a passenger compartment or cab 9. In the exemplary embodiment shown, motor vehicle 4 includes a cargo box 12 having a first end 15 arranged adjacent to cab 9, a second end 17, and a base portion 20 extending therebetween. Cargo box 12 also includes a first side wall 22 and an opposing second side wall 23. First and second side walls 22 and 23 extend between first end 15 and second end 17.

Cargo box 12 includes an end gate 30 pivotally mounted between first and second side walls 22 and 23 at second end 17. End gate 30 includes a body 36 having a first surface 38 an opposing second surface 40 and an end portion 42. End gate 30 further includes a first side portion 44 and a second side portion 46. End portion 42 extends between first and second side portions 44 and 46. A step 48 may be formed in first surface 38. As will become more fully evident herein, step 48 may be used to assist individuals in entering cargo box 12. End gate 30 is also shown to include an end gate handle 50 (FIG. 2) that facilitates opening and closing end gate 30.

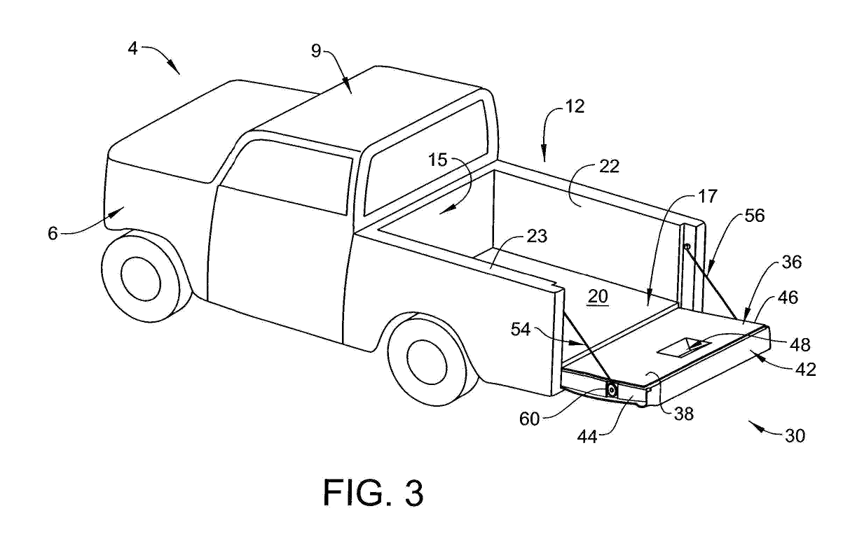

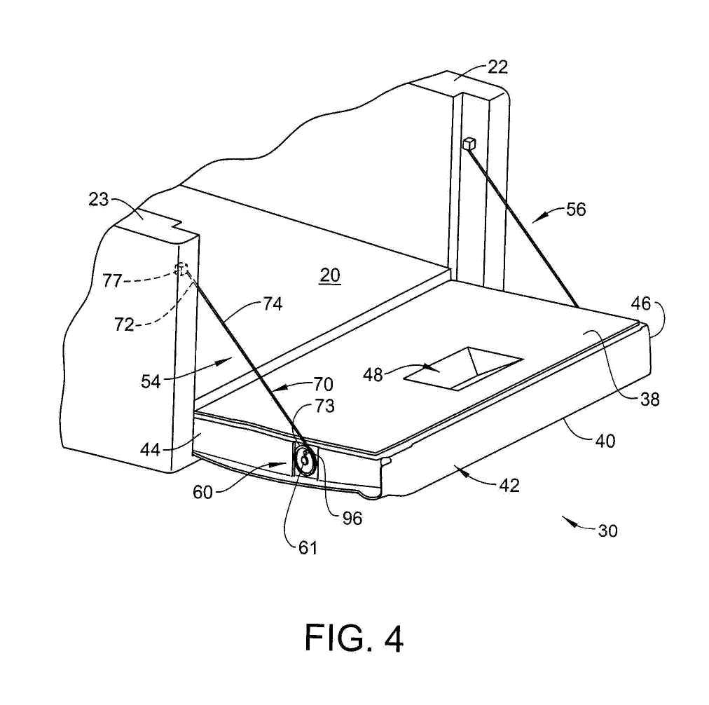

Referring to FIG. 3, in accordance with an exemplary embodiment, end gate 30 is connected to first and second side walls 22 and 23 through a first selectively releasable support member 54 and a second selectively releasable support member 56. As shown in FIG. 4, first selectively releasable support member 54 is coupled to a first selectively releasable pulley 60 rotatably mounted to first side portion 44 through a support member 61. Second selectively releasable support member 56 is coupled to a second selectively releasable pulley (not shown) mounted to second side portion 46.

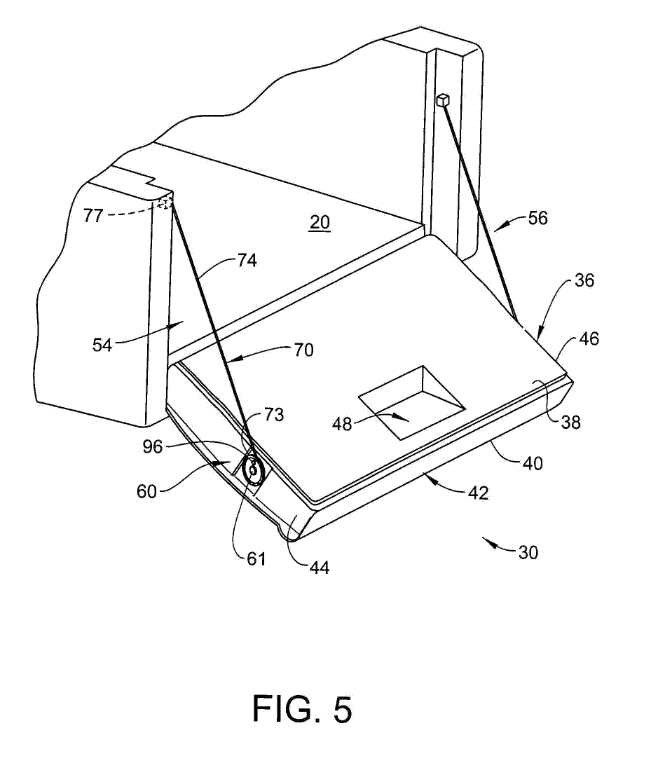

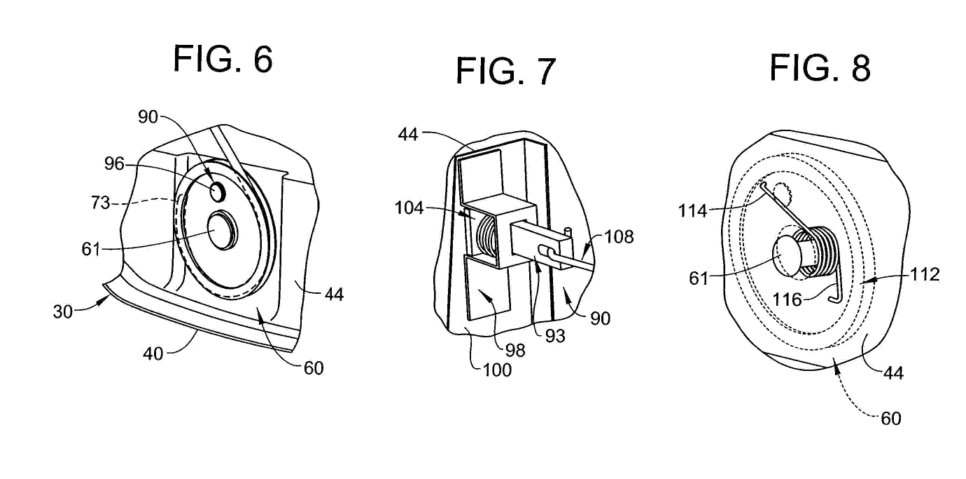

In accordance with an aspect of an exemplary embodiment, each selectively releasable support member 54 and 56 may take the form of a flexible cable such as that indicated at 70. First selectively releasable support member 54 includes a first end 72, a second end 73 and an intermediate section 74 extending therebetween. First end 72 is coupled to first side wall 22 through a first anchor member 77. Second end 73 is coupled to selectively releasable pulley 60, FIG. 6. Second selectively releasable support member 56 is similarly formed and connected. As will be detailed below end gate 30 is selectively pivotable between a closed position (FIG. 2), a first open position, as shown in FIGS. 3 and 4, wherein end gate 30 extends at a first angle relative to base portion 20, and a second open position, as shown in FIGS. 1 and 5, wherein end gate 30 extends at a second angle, greater than the first angle, relative to base portion 20.

In accordance with another aspect of an exemplary embodiment, illustrated in FIGS. 6 and 7, end gate 30 includes a release mechanism 90 that selectively releases first selectively releasable pulley 60 and the second selectively releasable pulley (not shown). Release mechanism 90 is partially enclosed within end gate 30 and includes an actuator or release element 93 (FIG. 7) that extends from within end gate 30 through first side portion 44 and includes an end section 96 (FIG. 6) that may selectively project through selectively releasable pulley 60. Release element 93 is supported by a release element support 98 mounted to an internal surface 100 of first side portion 44. A second release element (not separately labeled) and release element support (also not separately labeled) may be provided at second side potion 46 to selectively release the second selectively releasable pulley.

Release element 93 is laterally outwardly biased by a spring mechanism 104. Spring mechanism 104 maintains release element 93 in a locked position, such as that shown in FIG. 6. An actuation element or rod 108 extends within end gate 30 from release element 93 to end gate handle 50. Actuation rod 108 may also connect to the second release element if so provided. In this manner, a user may activate end gate handle 50 to release end gate 30 to the third position. Activation of end gate handle 50 causes release element 93 to withdraw inwardly allowing selectivly releasable pulley 60 to rotate. Rotation of selectively releasable pulley 60 allows selectively releasable support member 54 to unroll permitting end gate 30 to pivot from the second position to the third position.

When returning to the second position, a user may simply raise end gate 30. A return spring element 112, shown in FIG. 8, includes a first end 114 coupled to first side portion 44 and a second end 116 coupled to first selectively releasable pulley 60. Return spring 112 promotes a reverse rotation of selectively releasable pulley 60, winding selectively releasable support member 54 thereabout. When in proper position, spring mechanism 104 urges end section 96 of release element 93 through selectively releasable pulley 60 locking end gate 30 in the second position. The user may then simply raise end gate 30 to the first position. Latches (not shown) retain end gate 30 in the first position.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the invention not be limited to the particular embodiments disclosed, but will include all embodiments falling within the scope of the application.

1. A cargo box for a pickup truck comprising:
a base portion including a first end, a second end, and an intermediate portion defining the cargo box;
a first side wall extending from the first end towards the second end on a first side of the cargo box, the first side wall including a first end portion;
a second side wall extending from the first end towards the second end on a second side of the cargo box, the second side wall including a second end portion;
an end gate having first side portion, a second side portion, a surface extending between the first and second side portions, and an end portion, the end gate being pivotally mounted at the second end of the base portion, the end gate including a selectively releasable support member, the end gate being shiftable between a first position wherein the end gate is linked to the first and second side walls, a second position wherein the end gate is arranged at a first angle relative to the base portion, and upon release of the selectively releasable support member a third position wherein the end gate is arranged at a second angle, greater than the first angle, relative to the base portion, and
a step formed substantially centrally between the first and second side portions in the surface adjacent the end portion.

2. The cargo box according to claim 1, further comprising: at least one selectively releasable pulley mounted to the end gate, the selectively releasable support member extending from the at least one selectively releasable pulley to one of the first and second side walls.

3. The cargo box according to claim 2, wherein the end gate includes a first side portion and an opposing second side portion, the at least one selectively releasable pulley being mounted to one of the first and second side portions.

4. The cargo box according to claim 3, further comprising: a release mechanism mounted to the end gate and selectively linked with the at least one selectively releasable pulley, the release mechanism being operable to release the selectively releasable pulley allowing the end gate to transition between the second position and the third position.

5. The cargo box according to claim 4, further comprising: an end gate handle mounted to the end gate, the end gate handle being operatively coupled to the release mechanism.

6. The cargo box according to claim 5, wherein the end gate handle is mounted to the end gate substantially centrally between the first and second side portions.

7. The cargo box according to claim 5, wherein the release mechanism includes a spring element and a release element, the spring element biasing the release element into the at least one selectively releasable pulley.

8. The cargo box according to claim 7, wherein the end gate handle is mechanically linked to the spring element through an actuator element.

9. The cargo box according to claim 2, wherein the selectively releasable support member comprises a flexible cable having a first end coupled to the at least one selectively releasable pulley and a second end coupled to the cargo box.

10. The cargo box according to claim 9, further comprising: an anchor member mounted to one of the first and second side walls, the second end of the flexible cable being connected to the anchor member.

11. A vehicle comprising:
a body; and
a cargo box mechanically connected to the body, the cargo box comprising:
a base portion including a first end, a second end, and an intermediate portion defining a cargo box;
a first side wall extending from the first end towards the second end on a first side of the cargo box, the first side wall including a first end portion;
a second side wall extending from the first end towards the second end on a second side of the cargo box, the second side wall including a second end portion;
an end gate having first side portion, a second side portion, a surface extending between the first and second side portions, and an end portion, the end gate being pivotally mounted at the second end of the base portion, the end gate including a selectively releasable support member, the end gate being shiftable between a first position wherein the end gate is linked to the first and second side walls, a second position wherein the end gate is arranged at a first angle relative to the base portion, and upon release of the selectively releasable support member a third position wherein the end gate is arranged at a second angle, greater than the first angle, relative to the base portion, and
a step formed substantially centrally between the first and second side portions in the surface adjacent the end portion.

12. The vehicle according to claim 11, further comprising: at least one selectively releasable pulley mounted to the end gate, the selectively releasable support member extending from the at least one selectively releasable pulley to one of the first and second side walls.

13. The vehicle according to claim 12, wherein the end gate includes a first side portion and an opposing second side portion, the at least one selectively releasable pulley being mounted to one of the first and second side portions.

14. The vehicle according to claim 13, further comprising: a release mechanism mounted to the end gate and selectively linked with the at least one selectively releasable pulley, the release mechanism being operable to release the selectively releasable pulley allowing the end gate to transition between the second position and the third position.

15. The vehicle according to claim 14, further comprising: an end gate handle mounted to the end gate, the end gate handle being operatively coupled to the release mechanism.

16. The vehicle according to claim 15, wherein the end gate handle is mounted to the end gate substantially centrally between the first and second side portions.

17. The vehicle according to claim 15, wherein the release mechanism includes a spring element and a release element, the spring element biasing the release element into the at least one selectively releasable pulley.

18. The vehicle according to claim 17, wherein the end gate handle is mechanically linked to the spring element through an actuator element.

19. The vehicle according to claim 12, wherein the selectively releasable support member comprises a flexible cable having a first end coupled to the at least one selectively releasable pulley and a second end coupled to the cargo box.

20. The vehicle according to claim 19, further comprising: an anchor member mounted to one of the first and second side walls, the second end of the flexible cable being connected to the anchor member.
